(19) United States
(12) Patent Application Publication
(10) Pub. No.: US 2026/0329204 A1
(43) Pub. Date: Oct. 22, 2026

(54) DEVELOPING ROLLER, DEVELOPMENT DEVICE, AND IMAGE FORMING APPARATUS

(71) Applicant: KYOCERA Document Solutions Inc., Osaka (JP)

(72) Inventors: Yukimasa WATANABE, Osaka (JP); Kazuaki EZURE, Osaka (JP); Makoto SHISHIDO, Osaka (JP); Shoji ITSUMI, Osaka (JP)

(73) Assignee: KYOCERA Document Solutions Inc., Osaka (JP)

(21) Appl. No.: 19/468,745

(22) Filed: Feb. 3, 2026

(30) Foreign Application Priority Data
Feb. 7, 2025 (JP) 2025-018982

(51) Int. Cl. G03G 15/09; H01F 1/053; H01F 1/11

(52) U.S. Cl. CPC G03G 15/0928; H01F 1/053; H01F 1/11; G03G 2215/0609

(57) ABSTRACT

A developing roller includes a shaft, a plurality of magnets, and a development sleeve. The plurality of magnets are fixed to the outer circumferential surface of the shaft and extend in the axial direction of the shaft. The magnets are configured to contain, as materials, a magnetic powder, a chlorinated polyethylene, a polyolefin elastomer, and an ethylene-ethyl acrylate copolymer. The addition ratio of the ethylene ethyl acrylate copolymer is in a range of 10 mass % to 35 mass % of the organic substances other than the magnetic powder.

### INCORPORATION BY REFERENCE

This application is based on and claims the benefit of priority from Japanese Patent Application No. 2025-018982 filed on Feb. 7, 2025, the contents of which are hereby incorporated by reference.

### BACKGROUND

The present disclosure relates to a developing roller, a development device, and an image forming apparatus.

Electrophotographic image forming apparatuses such as copiers and printers widely use a development device that feeds toner to an electrostatic latent image formed on an outer circumferential surface of an image carrying member such as a photosensitive drum to develop it into a toner image to be later transferred to a sheet (recording medium). The development device includes a developing roller that carries, on its outer circumferential surface, developer containing toner stored in a developer container to feed it to the photosensitive drum.

### SUMMARY

According to one aspect of the present disclosure, a developing roller includes a shaft, a plurality of magnets, and a development sleeve. The plurality of magnets are fixed to the outer circumferential surface of the shaft and extend in the axial direction of the shaft. The development sleeve is arranged to face the magnets across a predetermined interval from the magnets outward in a radial direction. The magnets are configured to contain, as materials, a magnetic powder, a chlorinated polyethylene, a polyolefin elastomer, and an ethylene-ethyl acrylate copolymer. The addition ratio of the ethylene-ethyl acrylate copolymer is in a range of 10 mass % to 35 mass % of the organic substances other than the magnetic powder.

### BRIEF DESCRIPTION OF THE DRAWINGS

FIG. 1 is a schematic sectional front view of an image forming apparatus according to one embodiment of the present disclosure.

FIG. 2 is a schematic sectional front view around an image forming portion in the image forming apparatus in FIG. 1.

FIG. 3 is an enlarged view around a developing roller in a development device in the image forming portion in FIG. 2.

FIG. 4 is an illustrative diagram showing a first stage of the assembly of the developing roller in FIG. 3.

FIG. 5 is an illustrative diagram showing a second stage of the assembly of the developing roller in FIG. 3.

FIG. 6 is an illustrative diagram showing the specifications of the magnetic characteristics of magnets in the developing roller in FIG. 3.

### DETAILED DESCRIPTION

An embodiment of the present disclosure will be described below with reference to the accompanying drawings. The present disclosure is not limited to what is specifically described below.

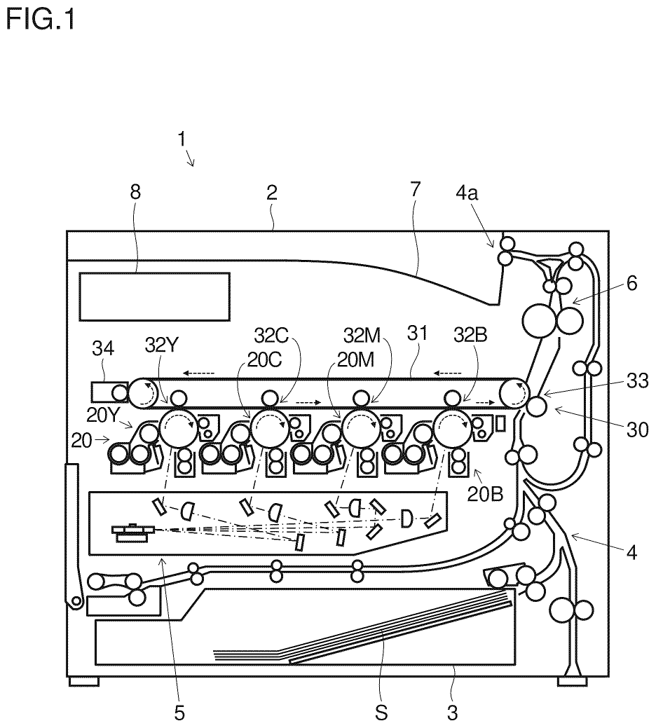

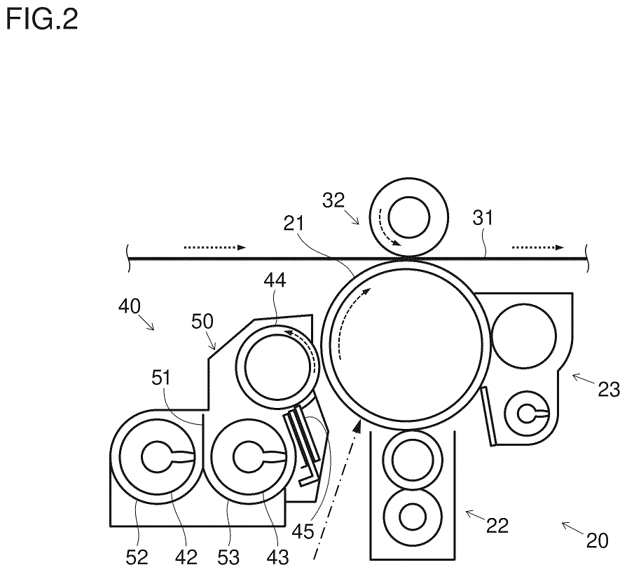

FIG. 1 is a schematic sectional front view of an image forming apparatus 1 according to the embodiment. FIG. 2 is a schematic sectional front view around an image forming portion 20 in the image forming apparatus 1 in FIG. 1. One example of the image forming apparatus 1 of this embodiment is a tandem-type color printer that transfers a toner image to a sheet S by using an intermediate transfer belt 31. The image forming apparatus 1 may be what is called a multifunction peripheral that has functions such as printing, scanning (image reading), and facsimile transmission.

As shown in FIGS. 1 and 2, the image forming apparatus 1 includes, in its main body 2, a sheet feeding portion 3, a sheet conveyance portion 4, an exposure portion 5, an image forming portion 20, a transfer portion 30, a fixing portion 6, a sheet discharging portion 7, and a control portion 8.

The sheet feeding portion 3 is arranged at the bottom of the main body 2. The sheet feeding portion 3 accommodates a plurality of unprinted sheets S and feeds out the sheets S one by one during printing. The sheet conveyance portion 4 extends along a side wall of the main body 2 in the up-down direction. The sheet conveyance portion 4 conveys the sheet S fed out from the sheet feeding portion 3 to a secondary transfer portion 33 and to the fixing portion 6 and then discharges the sheet S after fixing through a sheet discharging port 4a to the sheet discharging portion 7.

The exposure portion 5 is arranged above the sheet feeding portion 3. The exposure portion 5 irradiates a photosensitive drum 21 in the image forming portion 20 with laser light controlled based on image data.

The image forming portion 20 is arranged above the exposure portion 5, below the intermediate transfer belt 31. The image forming portion 20 includes an image forming portion 20Y for yellow, an image forming portion 20C for cyan, an image forming portion 20M for magenta, and an image forming portion 20B for black. The four image forming portions 20 have a similar basic configuration. Accordingly, unless necessary, the suffixes “Y”, “C”, “M”, and “B” representing the different colors may be omitted in the following description.

The image forming portion 20 includes the photosensitive drum (image carrying member) 21 that is supported so as to be rotatable in a predetermined direction (clockwise in FIGS. 1 and 2). The image forming portion 20 further includes, arranged around the photosensitive drum 21 along its rotation direction, a charging portion 22, a development device 40, and a drum cleaning portion 23. A primary transfer portion 32 is arranged between the development device 40 and the drum cleaning portion 23.

The photosensitive drum 21 is formed in a cylindrical shape extending in the horizontal direction and has on its outer circumferential surface a photosensitive layer formed of, for example, an amorphous silicon photosensitive material. The charging portion 22 electrostatically charges the surface (outer circumferential surface) of the photosensitive drum 21 to a predetermined potential. The exposure portion 5 exposes to light the outer circumferential surface of the photosensitive drum 21 electrostatically charged by the charging portion 22 to form an electrostatic latent image of a document image on the outer circumferential surface of the photosensitive drum 21. The development device 40 feeds toner to the electrostatic latent image to develop it into a toner image. The four image forming portions 20 form toner images of different colors. After the toner image is primarily transferred to the outer circumferential surface of the intermediate transfer belt 31, the drum cleaning portion 23 cleans the outer circumferential surface of the photosensitive drum 21 by removing toner and other deposits on it. In this way, the image forming portion 20 forms an image (toner image) which will be transferred to the sheet S later.

The transfer portion 30 includes the intermediate transfer belt 31, primary transfer portions 32Y, 32C, 32M, and 32B, the secondary transfer portion 33, and a belt cleaning portion 34. The intermediate transfer belt 31 is arranged above the four image forming portions 20. The intermediate transfer belt 31 is an endless intermediate transferring member that is supported so as to be rotatable in a predetermined direction (counterclockwise in FIG. 1) and to which the toner images formed in the four image forming portions 20 are, while being sequentially overlaid on each other, primarily transferred. The four image forming portions 20 are arranged in what is called a tandem formation in which they are lined up in a row from upstream to downstream in the rotation direction of the intermediate transfer belt 31.

The primary transfer portions 32Y, 32C, 32M, and 32B are arranged above the image forming portions 20Y, 20C, 20M, and 20B for different colors with the intermediate transfer belt 31 in between. The secondary transfer portion 33 is arranged upstream of the fixing portion 6 with respect to the sheet conveyance direction of the sheet conveyance portion 4, downstream of the four image forming portions 20Y, 20C, 20M, and 20B with respect to the rotation direction of the intermediate transfer belt 31. The belt cleaning portion 34 is arranged downstream of the secondary transfer portion 33 with respect to the rotation direction of the intermediate transfer belt 31.

The primary transfer portion 32 transfers the toner image formed on the outer circumferential surface of the photosensitive drum 21 to the intermediate transfer belt 31. In other words, the toner image is primarily transferred to the outer circumferential surface of the intermediate transfer belt 31 in the primary transfer portions 32Y, 32C, 32M, and 32B for different colors. As the intermediate transfer belt 31 rotates, the toner images in the four image forming portions 20 are sequentially overlaid on each other and transferred to the intermediate transfer belt 31 with predetermined timing, so that a color toner image in which the toner images of four colors, namely yellow, cyan, magenta, and black, are overlaid on each other is formed on the outer circumferential surface of the intermediate transfer belt 31.

The color toner image on the outer circumferential surface of the intermediate transfer belt 31 is transferred, at a secondary transfer nip portion formed in the secondary transfer portion 33, to the sheet S fed synchronously from the sheet conveyance portion 4. After secondary transfer, the belt cleaning portion 34 cleans the outer circumferential surface of the intermediate transfer belt 31 by removing toner and other deposits on it. In this way, the transfer portion 30 transfers (records) the toner image formed on the outer circumferential surface of the photosensitive drum 21 to the sheet S.

The fixing portion 6 is arranged above the secondary transfer portion 33. The fixing portion 6 heats and presses the sheet S having the toner image transferred to it and thereby fixes the toner image to the sheet S.

The sheet discharging portion 7 is arranged above the transfer portion 30. The sheet S having the toner image fixed to it and having completed printing is conveyed to the sheet discharging portion 7. The sheet discharging portion 7 permits the printed sheet (print result) to be taken out from above.

The control portion 8 includes a CPU, an image processing portion, a storage portion, and other electronic circuits and electronic components (none is illustrated). Based on control programs and data stored in the storage portion, the CPU controls the operation of different components provided in the image forming apparatus 1 and to perform processes related to the functions of the image forming apparatus 1. The sheet feeding portion 3, the sheet conveyance portion 4, the exposure portion 5, the image forming portion 20, the transfer portion 30, and the fixing portion 6 individually receive commands from the control portion 8 and cooperate to print on the sheet S. The storage portion is configured as, for example, a combination of a non-volatile storage device such as a program ROM (read-only memory) and a data ROM, and a volatile storage device such as a RAM (random-access memory).

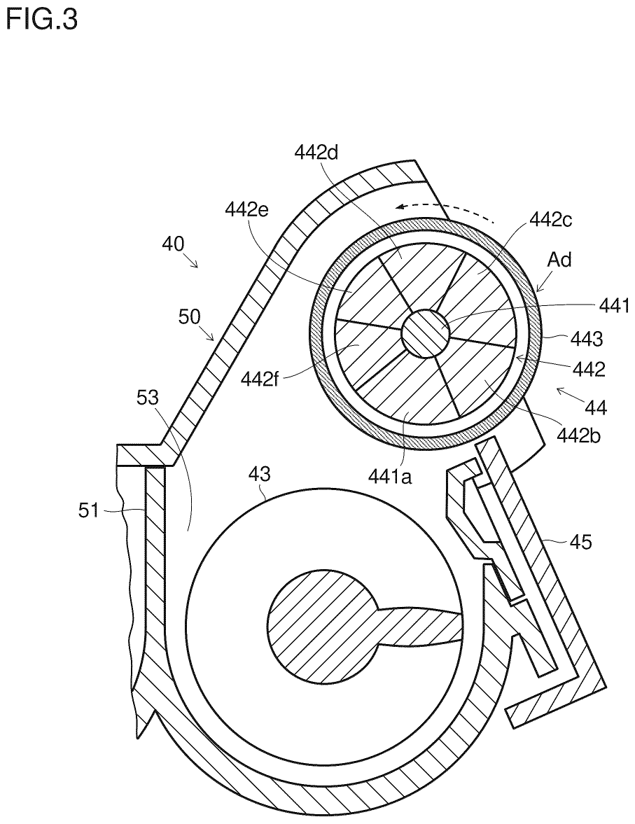

Next, the configuration of the development device 40 will be described with reference to FIG. 2 and also to FIG. 3. FIG. 3 is an enlarged view around a developing roller 44 in the development device 40 in the image forming portion 20 in FIG. 2. The development devices 40 for different colors have a similar basic configuration, so the suffixes distinguishing components for different colors will be omitted and no overlapping description will be repeated. In the following description, “the axial direction” represents the axial direction (the near-far direction with respect to the plane of FIGS. 2 and 3) of the rotation of any of the photosensitive drum 21, a first conveyance member 42, a second conveyance member 43, and a developing roller 44, which extend parallel to each other.

The development device 40 feeds toner to the outer circumferential surface of the photosensitive drum 21. The development device 40 is removably attachable, for example, with respect to the main body 2 of the image forming apparatus 1. As shown in FIGS. 2 and 3, the development device 40 includes a developer container 50, a first conveyance member 42, a second conveyance member 43, a developing roller (developer carrying member) 44, and a regulation member 45.

The developer container 50 is in a shape elongate along the axial direction of the photosensitive drum 21 and is arranged with its longitudinal direction horizontally aligned. That is, the longitudinal direction of the developer container 50 is parallel to the axial direction of the photosensitive drum 21. The developer container 50 stores, as developer containing toner fed to the photosensitive drum 21, for example, two-component developer containing toner and magnetic carrier.

The developer container 50 has a partition portion 51, a first conveyance chamber 52, and a second conveyance chamber 53.

The partition portion 51 is provided in a lower part in the developer container 50. The partition portion 51 is arranged substantially in a middle part of the developer container 50 in a direction (the left-right direction in FIG. 2) crossing the longitudinal direction. The partition portion 51 is formed substantially in a plate form extending in the longitudinal and up-down directions of the developer container 50. The partition portion 51 divides the interior of the developer container 50 in a direction crossing the longitudinal direction.

The first and second conveyance chambers 52 and 53 are provided in the developer container 50. The first and second conveyance chambers 52 and 53 are formed by the partition portion 51 dividing the interior of the developer container 50. The first and second conveyance chambers 52 and 53 are arranged side by side substantially at the same height.

The second conveyance chamber 53 occupies a space in the developer container 50 around a region where the developing roller 44 is arranged and is arranged adjacent to the photosensitive drum 21. The first conveyance chamber 52 is arranged in a region in the developer container 50 farther away from the photosensitive drum 21 than the second conveyance chamber 53. The first conveyance chamber 52 has a developer supplying port (not shown) open in it and through the developer supplying port developer is supplied into the developer container 50.

The developer container 50 includes developer communication portions (not shown) arranged outward of opposite ends of the partition portion 51 in the longitudinal direction. The first and second conveyance chambers 52 and 53 communicate with each other through the two developer communication portions arranged at opposite ends in the longitudinal direction. The developer moves between the first and second conveyance chambers 52 and 53 through the two developer communication portions.

The first conveyance member 42 is arranged in the first conveyance chamber 52. The second conveyance member 43 is arranged in the second conveyance chamber 53. The first and second conveyance members 42 and 43 are arranged side by side substantially at the same height. The second conveyance member 43 is arranged close to and extends parallel to the developing roller 44. The first and second conveyance members 42 and 43 are supported on the developer container 50 so as to be rotatable about an axis extending parallel to the developing roller 44 in the horizontal direction.

The first and second conveyance members 42 and 43 have a similar basic configuration. The first and second conveyance members 42 and 43 have a conveyance blade formed in a spiral shape on an outer circumferential part of a rotation shaft extending along the longitudinal direction of the developer container 50. The first and second conveyance members 42 and 43 rotate about their axis to convey, while stirring, the developer in opposite directions along the axial direction (longitudinal direction) and to circulate the developer in a predetermined conveyance direction.

The developing roller 44 is located above the second conveyance member 43 in the developer container 50 and is arranged to face the photosensitive drum 21. The developing roller 44 is supported on the developer container 50 so as to be rotatable about an axis extending parallel to the axis of the photosensitive drum 21.

Part of the outer circumferential surface of the developing roller 44 is exposed out of the developer container 50 and closely faces the photosensitive drum 21. The developing roller 44 carries on its outer circumferential surface the toner to be fed to the outer circumferential surface of the photosensitive drum 21 in a facing region Ad in which the developing roller 44 faces the photosensitive drum 21. The developing roller 44 carries the toner in the second conveyance chamber 53 in the developer container 50 and feeds it to the photosensitive drum 21. In other words, the developing roller 44 attaches the toner in the second conveyance chamber 53 to the electrostatic latent image on the outer circumferential surface of the photosensitive drum 21 to form a toner image.

The regulation member 45 is arranged upstream, in the rotation direction of the developing roller 44, of the facing region Ad where the developing roller 44 faces the photosensitive drum 21. The regulation member 45 closely faces the developing roller 44 and is arranged with a predetermined interval between its tip end and the outer circumferential surface of the developing roller 44. The regulation member 45 extends over the entire range of the developing roller 44 along its axial direction. The regulation member 45 regulates the layer thickness of the developer passing through the gap between the tip end of the regulation member 45 and the outer circumferential surface of the developing roller 44 while being carried on the outer circumferential surface of the developing roller 44.

The developer in the developer container 50 circulates between the first and second conveyance chambers 52 and 53 in a predetermined circulation direction through the two developer communication portions as the first and second conveyance members 42 and 43 rotate. Meanwhile, the toner in the developer container 50 is stirred to be electrostatically charged and is carried on the outer circumferential surface of the developing roller 44. The developer carried on the outer circumferential surface of the developing roller 44 has its layer thickness regulated by the regulation member 45 and is conveyed, as the developing roller 44 rotates, to the facing region Ad where the developing roller 44 faces the photosensitive drum 21. When a predetermined development voltage is applied to the developing roller 44, due to the potential difference from the potential on the surface (outer circumferential surface) of the photosensitive drum 21, the toner in the developer carried on the outer circumferential surface of the developing roller 44 moves to the outer circumferential surface of the photosensitive drum 21 in the facing region Ad. Thus, the electrostatic latent image on the outer circumferential surface of the photosensitive drum 21 is developed with toner.

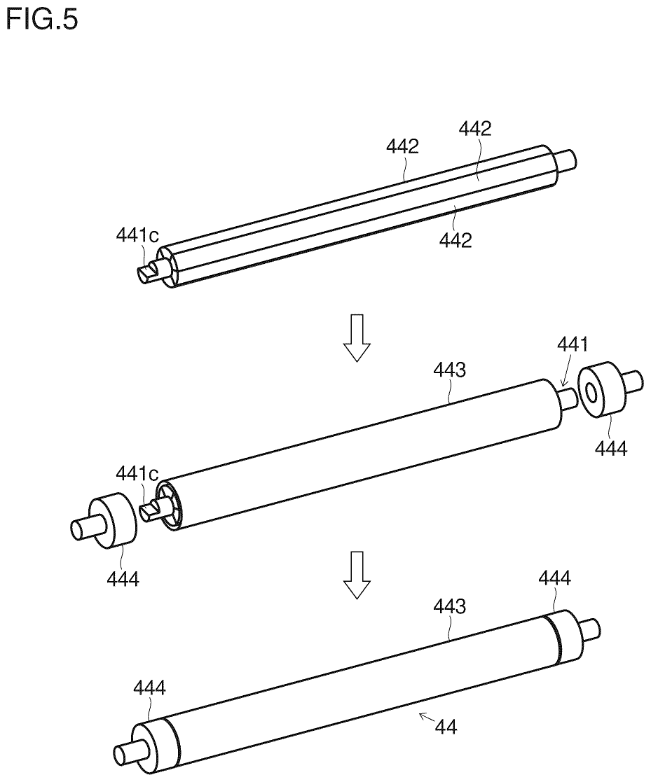

Next, the structure of the developing roller 44 will be described in detail. The developing roller 44 includes a shaft 441, a plurality of magnets 442, a development sleeve 443, and flange members 444 (see FIG. 5).

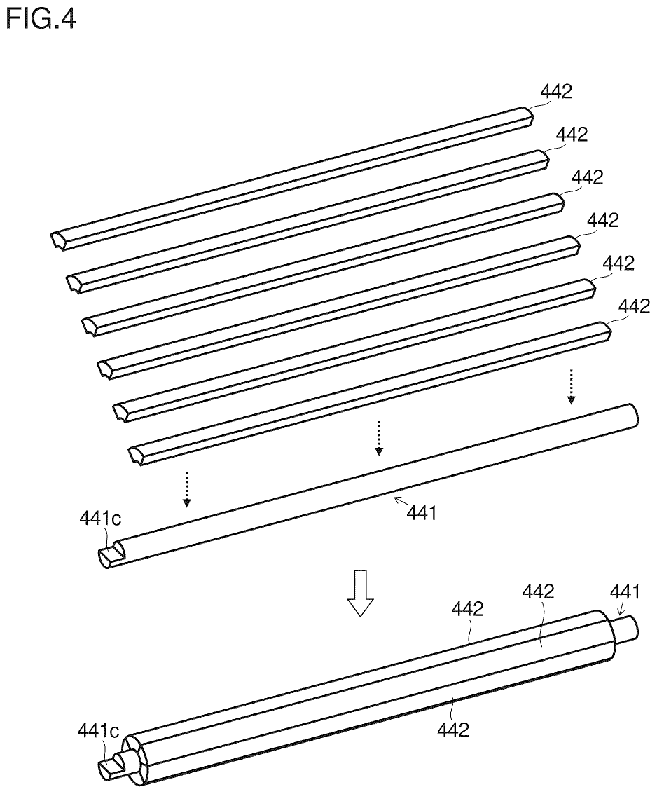

The shaft 441 is formed in a cylindrical shape (rod shape) out of a metallic material such as steel, and extends parallel to the axis of the photosensitive drum 21. The shaft 441 is positioned at the center of the developing roller 44 in the radial direction and extends along the axial direction of the developing roller 44. The shaft 441 has, at its one end in the axial direction, a D-cut face 441c (see FIG. 4) that has a D-shaped cross-sectional shape in the radial direction and is fixed to a developer container 50 via the D-cut face 441c so as not to be rotatable.

The plurality of magnets 442 are arranged side by side along the circumferential direction on the outer circumferential surface of the shaft 441 and are fixed to the outer circumferential surface of the shaft 441. The plurality of magnets 442 have a fan-shaped cross-sectional shape in the radial direction and extends in the axial direction of the shaft 441. The length of the magnet 442 in the axial direction is smaller than the length of the shaft 441 in the axial direction. The plurality of magnets 442 are, for example with adhesive, bonded and fixed to the outer circumferential surface of the shaft 441.

In this embodiment, six magnets 442 are arranged side by side along the circumferential direction on the outer circumferential surface of the shaft 441. That is, the developing roller 44 has six magnetic poles arranged along the circumferential direction (the rotation direction of the development sleeve 443). The six magnetic poles (magnets 442) comprise an attraction pole 442a, a regulation pole 442b, a development pole 442c, a conveyance pole 442d, a removal pole 442e, and an isolation pole 442f.

The attraction pole 442a is arranged upstream of the regulation member 45 in the rotation direction of the development sleeve 443, at a position facing the second conveyance member 43 across the development sleeve 443. The attraction pole 442a generates a peak magnetic force (magnetic flux density) at the position facing the second conveyance member 43. The magnetic force of the attraction pole 442a attracts the developer being conveyed and stirred by the second conveyance member 43 to the outer circumferential surface of the development sleeve 443.

The regulation pole 442b is arranged downstream of the attraction pole 442a in the rotation direction of the development sleeve 443, at a position facing the regulation member 45 across the development sleeve 443. The regulation pole 442b generates a peak magnetic force (magnetic flux density) at the position facing the regulation member 45. The magnetic force of the regulation pole 442b and the regulation member 45 regulate the layer thickness of the developer carried on the outer circumferential surface of the development sleeve 443.

The development pole 442c is arranged downstream of the regulation pole 442b in the rotation direction of the development sleeve 443, at a position facing the facing region Ad facing the photosensitive drum 21. The development pole 442c generates a peak magnetic force (magnetic flux density) in the facing region Ad facing the photosensitive drum 21. While the magnetic force of the development pole 442c leaves the developer carried on the outer circumferential surface of the development sleeve 443, the development bias makes only the toner fly onto the photosensitive drum 21, so that the electrostatic latent image on the surface of the photosensitive drum 21 is developed.

The conveyance pole 442d is arranged downstream of the development pole 442c in the rotation direction of the development sleeve 443. Under the magnetic force of the conveyance pole 442d, the developer is carried on the outer circumferential surface of the development sleeve 443 to be conveyed, as the development sleeve 443 rotates, in its rotation direction.

The removal pole 442e is arranged downstream of the conveyance pole 442d in the rotation direction of the development sleeve 443, upstream of the attraction pole 442a in the rotation direction of the development sleeve 443. The developer having reached the removal pole 442e as the development sleeve 443 rotates is removed from the outer circumferential surface of the development sleeve 443 and falls downward in the second conveyance chamber 53.

The isolation pole 442f is arranged downstream of the removal pole 442e in the rotation direction of the development sleeve 443, between the attraction pole 442a and the removal pole 442e in the circumferential direction. The magnetic force of the isolation pole 442f prevents the lines of magnetic force of the removal pole 442e from passing around toward the attraction pole 442a.

The development sleeve 443 is formed in a cylindrical shape out of a metallic material such as aluminum, and extends parallel to the axis of the photosensitive drum 21. Both ends of the development sleeve 443 in the axial direction are open. The development sleeve 443 is arranged to face the magnets 442 across a predetermined interval from it outward in the radial direction. The length of the development sleeve 443 in the axial direction is substantially equal to the length of the magnets 442 in the axial direction. The development sleeve 443 is supported on a developer container 50 via the flange members 444 so as to be rotatable about the axial direction of the shaft 441 and rotates by being driven by a driving mechanism (not shown). The developer is carried on the outer circumferential surface of the development sleeve 443.

The flange members 444 (see FIG. 5) are formed of a metallic material such as aluminum, and are fixed to the openings at opposite ends of the development sleeve 443 in the axial direction. The flange member 444 at one end in the axial direction is coupled to the driving mechanism (not shown). Thus, the flange member 444 receives driving power from the driving mechanism to rotate together with the development sleeve 443 about the axis of the shaft 441.

FIGS. 4 and 5 are illustrative diagrams showing a first stage and a second stage of the assembly of the developing roller 44 in FIG. 3.

As shown in FIG. 4, the six magnets 442 are each bonded with adhesive to the outer circumferential surface of the shaft 441. The first magnet 442 is manually bonded, for example, with the D-cut face 441c on the shaft 441 as a reference position. The second and following magnets 442 are manually bonded, with the first magnet 442 as a reference position, continuously one adjacent to another along the circumferential direction of the shaft 441. This completes the assembly of a magnet roller comprising six magnets 442 fixed side by side along the circumferential direction on the outer circumferential surface of the shaft 441.

As shown in FIG. 5, the magnet roller comprising the shaft 441 and six magnets 442 are inserted in the development sleeve 443. At the openings in opposite ends of the development sleeve 443 in the axial direction, the flange members 444 are fixed with adhesive. The development sleeve 443 and the two flange members 444 are configured integrally and moves rotationally relative to the magnet roller comprising the shaft 441 and the six magnets 442.

Next, the configuration of the magnets 442 will be described in detail. The magnets 442 need to be formed with appropriate hardness to prevent problems such as curvature of the magnets 442 in the axial direction or elevations and depressions of the magnets 442 in the radial direction.

As for the curvature of the magnets 442, for example, if the magnets 442 deviate by 0.1 [mm] from the central axis, the magnetic angle deviates by approximately 1 [°]. As for elevations and depressions of the magnets 442, for example, if the magnets 442 deviate by 0.1 [mm] in the radial direction, the magnetic flux density changes by 2 to 3 [mT].

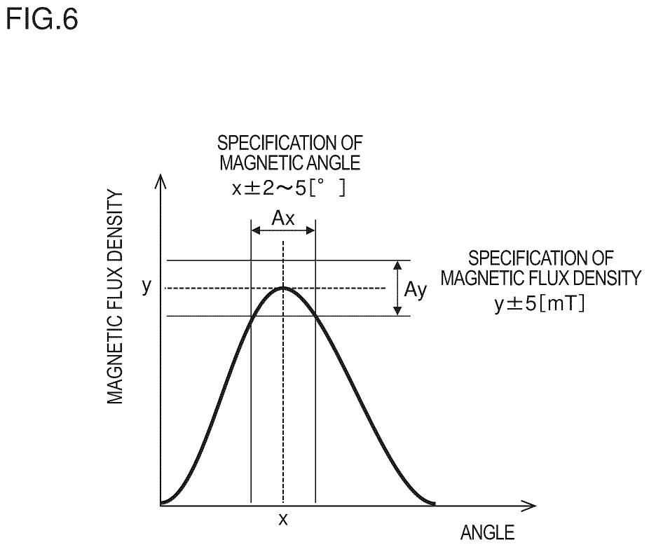

The magnetic angle and the magnetic flux density of the magnets 442 significantly affect image quality. That is, achieving high-quality image formation requires appropriate specifications for the magnetic angle and magnetic flux density of the magnets 442. FIG. 6 is an illustrative diagram showing the specifications of the magnetic characteristics of the magnets 442 in the developing roller 44 in FIG. 3.

Among the specifications of the magnetic characteristics, as shown in FIG. 6, the specification of the angle x, which is the center value of the magnetic angle range Ax where the magnetic force is 80% or more of the required peak magnetic force (magnetic flux density) y, requires that x be in the range of ±2 to 5 [°]. Particularly, for the development pole 442c and the regulation pole 442b, x is required to be in the range of ±2 to 3 [°].

Among the specifications of the magnetic characteristics, as shown in FIG. 6, the specification of the magnetic flux density requires that the magnetic flux density range Ay be y±5 [mT] with its center value at the required peak magnetic force (magnetic flux density) y.

Thus, the magnets 442 are configured to contain, as its materials, a magnetic powder, a chlorinated polyethylene (CPE), a polyolefin elastomer (POE), and an ethylene-ethyl acrylate copolymer (EEA).

As to the addition ratio of ethylene ethyl acrylate copolymer (EEA) in the magnets 442, the effect of the EEA addition ratio on the magnetic angle and the magnetic flux density of the magnet 442 was evaluated. Table 1 shows the values of the magnetic angle and the magnetic flux density of the development pole 442c in the magnets 442 corresponding to different addition ratios of ethylene ethyl acrylate copolymer (EEA).

TABLE 1

| | | | | | | | | | |
|---|---|---|---|---|---|---|---|---|---|
| Materials of Magnet | EEA [mass %] | 0 | 5 | 10 | 15 | 25 | 30 | 35 | 37 |
| | Others [mass %] | 40 | 35 | 30 | 25 | 15 | 10 | 5 | 3 |

| | | | | | | | | |
|---|---|---|---|---|---|---|---|---|
| Magnetic Flux Density (Mean Value) [mT] | 85 | 86 | 86 | 88 | 88 | 85 | 80 | 77 |
| Variation of Magnetic Angle in Axial Direction [°] | 7 | 5 | 2 | 2 | 2 | 2 | 3 | 5 |
| Variation of Magnetic Force in Axial Direction [mT] | 10 | 9 | 4 | 3 | 3 | 3 | 3 | 5 |

*Materials of Magnet: CPE = 35%, POE = 25%, Others = (40 - EEA) %

The specification of the magnetic angle of the development pole 442c is 0±3 [°] and the specification of the magnetic flux density of the development pole 442c is 85±5 [mT]. The addition ratio of ethylene ethyl acrylate copolymer (EEA) is, specifically, the addition ratio of ethylene ethyl acrylate copolymer (EEA) among the organic substances other than the magnetic powder. To the magnets 442 are added, as organic substances, 35 mass % of chlorinated polyethylene (CPE) and 25 mass % of polyolefin elastomer (POE). The magnets 442 contain, as its as “Other” materials, (40—(addition ratios of EEA)) mass % of additives such as a lubricant.

According to Table 1, if the addition ratio of ethylene ethyl acrylate copolymer (EEA) is less than 10 mass %, the variation of the magnetic angle in the axial direction is 5 [°] or more and the variation of the magnetic force in the axial direction is 9 [mT] or more, both exceeding the specifications of the magnetic angle and the magnetic flux density. Thus, if the addition ratio of ethylene ethyl acrylate copolymer (EEA) is less than 10 mass %, the magnets 442 are softer than intended and are easy to deform. This causes problems with the magnets 442 such as curvature of the magnets 442 in the axial direction or elevations and depressions of the magnets 442 in the radial direction, resulting in a magnetic angle and a magnetic flux density exceeding the specifications.

If the addition ratio of ethylene ethyl acrylate copolymer (EEA) is more than 35 mass %, the variation of the magnetic angle in the axial direction is 5 [°], the variation of the magnetic force in the axial direction is 6 [mT], and the magnetic flux density is 77 [mT], all exceeding the specifications of the magnetic angle and the magnetic flux density. Thus, if the addition ratio of ethylene ethyl acrylate copolymer (EEA) is more than 35 mass %, the magnetic powder in the magnets 442 has poor fluidity and tends to exhibit disturbed alignment. This causes problems with the magnets 442 such as degraded magnetic properties, resulting in a magnetic angle and a magnetic flux density exceeding the specifications.

Based on the above evaluation, the ethylene ethyl acrylate copolymer (EEA) in the magnets 442 has an addition ratio within the range of 10 mass % to 35 mass % of the organic substances other than the magnetic powder. This makes it possible to form the magnets 442 with appropriate hardness and to prevent problems such as curvature of the magnets 442 in the axial direction of the developing roller 44 or elevations and depressions of the magnets 442 in the radial direction. It is also possible to prevent a deviation in the magnetic angle of the developing roller 44 or a drop in magnetic flux density. Thus, the developing roller 44 can then have suitable magnetic characteristics.

If the addition ratio of polyolefin elastomer (POE) to chlorinated polyethylene (CPE) in the magnets 442 is less than 40 mass %, the resin may have poor fluidity during the extrusion and alignment of the magnets 442 and the desired magnetic force may not be obtained. If the addition ratio of polyolefin elastomer (POE) to chlorinated polyethylene (CPE) in the magnets 442 exceeds 85 mass %, the magnets 442 are too soft to be extrusion-molded. Thus, it is preferable that the addition ratio of polyolefin elastomer (POE) to chlorinated polyethylene (CPE) in the magnets 442 be within the range of 40 mass % to 85 mass %.

The magnetic powder in the magnets 442 is ferrite, and this makes it possible to obtain suitable magnetic characteristics using a common magnetic powder. That is, the magnets 442 can have suitable magnetic characteristics and can easily be formed to have an appropriate hardness.

The magnetic powder in the magnets 442 may contain a rare-earth magnetic powder in addition to ferrite. For example, the rare-earth magnetic powder can be a magnetic powder of a material such as neodymium or samarium. With this configuration, it is possible to give the magnets 442 a high magnetic force. Thus, on the image forming apparatus 1, it is possible to achieve high-quality image formation.

While an embodiment of the present disclosure has been described above, it is not meant to limit the scope of the present disclosure, which can thus be carried out with any modifications made without departure from the spirit of the disclosure.

For example, in the above embodiment, the image forming apparatus 1 is assumed to be what is called a tandem-type image forming apparatus for color printing that forms images of multiple colors while sequentially overlaying them on each other, but this is not meant as any limitation to such models; the image forming apparatus may be a color-printing image forming apparatus other than of a tandem type, or may be an image forming apparatus for monochrome printing.

What is claimed is:

1. A developing roller comprising:
a shaft;
a plurality of magnets fixed to an outer circumferential surface of the shaft, the plurality of magnets extending in an axial direction of the shaft; and
a development sleeve arranged to face the magnets across a predetermined interval from the magnets outward in a radial direction,
wherein
the magnets are configured to contain, as materials, a magnetic powder, a chlorinated polyethylene, a polyolefin elastomer, and an ethylene-ethyl acrylate copolymer,
an addition ratio of the ethylene ethyl acrylate copolymer is in a range of 10 mass % to 35 mass % of organic substances other than the magnetic powder.

2. The developing roller according to claim 1, wherein
an addition ratio of the polyolefin elastomer to the chlorinated polyethylene is in a range of 40 mass % to 85 mass %.

3. The developing roller according to claim 1, wherein
the magnetic powder in the magnets is ferrite.

4. The developing roller according to claim 3, wherein
the magnetic powder in the magnets contains a rare-earth magnetic powder.

5. A development device comprising:
a developer container that stores toner fed to an image carrying member; and
the developing roller according to claim 1 rotatably supported on the developer container so as to face the image carrying member, the developing roller feeding the toner in the developer container to the image carrying member.

6. An image forming apparatus comprising:
the development device according to claim 5.
